(19) United States
(12) Patent Application Publication
(10) Pub. No.: US 2026/0335724 A1
(43) Pub. Date: Oct. 29, 2026

(54) PORTABLE BOWLING BALL CUP ASSEMBLY

(71) Applicant: Antany D. Peppers, Columbus, OH (US)

(72) Inventor: Antany D. Peppers, Columbus, OH (US)

(21) Appl. No.: 19/660,061

(22) Filed: Apr. 27, 2026

Related U.S. Application Data
(60) Provisional application No. 63/794,494, filed on Apr. 25, 2025.
(60) Provisional application No. 63/794,507, filed on Apr. 25, 2025.
(60) Provisional application No. 63/794,516, filed on Apr. 25, 2025.

(51) Int. Cl. A63B 47/00; F16M 11/22

(52) U.S. Cl. CPC A63B 47/007; F16M 11/22

(57) ABSTRACT

A bowling ball support assembly comprising a plurality of link assemblies configured to be arranged in a radial configuration. Each link assembly comprises a bearing support and a roller ball bearing assembly supported by the bearing support. The roller ball bearing assembly comprises a rotatable ball. The rotatable balls of the roller ball bearing assemblies are positioned to collectively support a bowling ball in a rotational manner. The plurality of link assemblies are configured to be disassembled for storage and reassembled without tools.

### CROSS-REFERENCE TO RELATED APPLICATIONS

This application claims priority to U.S. Provisional Patent Application No. 63/794,494, titled CHAIN-STYLE BOWLING BALL SUPPORT ASSEMBLY, filed Apr. 25, 2025; U.S. Provisional Patent Application No. 63/794,507, titled PORTABLE BOWLING BALL CUP ASSEMBLY, filed Apr. 25, 2025; and U.S. Provisional Patent Application No. 63/794,516, titled PORTABLE BOWLING BALL CUP ASSEMBLY, filed Apr. 25, 2025; each of which is hereby incorporated by reference in its entirety.

### FIELD OF INVENTION

The present disclosure relates to bowling ball support devices, and more particularly to a portable bowling ball support assembly configured for rotational support and tool-free disassembly for storage.

### BACKGROUND

Bowling is a popular recreational activity enjoyed by millions of people worldwide. A piece of equipment in bowling is the bowling ball, which may benefit from proper care and maintenance to help ensure performance and longevity. Bowling balls are typically made of materials such as polyurethane, reactive resin, or particle-filled resin, and their surfaces can accumulate oil, dirt, and other debris during use.

Regular cleaning and maintenance of bowling balls are common practices for bowlers of various skill levels. Clean bowling balls may provide better traction on the lane, allowing for more consistent and accurate throws. Additionally, proper maintenance can extend the lifespan of the bowling ball by helping to prevent the accumulation of substances that may degrade the ball's surface over time.

Traditionally, bowlers have used various methods to clean and maintain their bowling balls, including wiping them down with microfiber towels, using specialized cleaning solutions, and periodically having them professionally resurfaced. However, these methods often involve manually rotating the ball to help ensure all areas of the surface are adequately treated.

Bowling ball support devices have been developed to assist in the cleaning and maintenance process. These devices typically aim to provide a stable platform for the bowling ball while allowing it to rotate freely, enabling easier access to all areas of the ball's surface. Some existing support devices utilize fixed cradles or cups, while others incorporate rotating mechanisms to facilitate ball movement.

One challenge in designing bowling ball support devices is balancing stability with ease of rotation. Additionally, portability and storage considerations are relevant factors, as many bowlers prefer equipment that can be easily transported to and from bowling alleys and conveniently stowed in a typical bowling bag.

Another aspect of bowling ball maintenance is the ability to inspect the ball's surface for signs of wear or damage. Support devices that allow for easy rotation can aid in thorough visual inspections, helping bowlers identify areas that may benefit from attention or professional servicing.

As the bowling industry continues to evolve, there is an ongoing interest in developing tools and accessories that can enhance the bowling experience and help players maintain their equipment more effectively. Innovations in this area may contribute to improved ball performance, increased longevity of bowling equipment, and potentially enhanced enjoyment of the sport for participants at various skill levels.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a bowling ball support assembly is provided. The bowling ball support assembly comprises a plurality of link assemblies configured to be arranged in a radial configuration. Each link assembly comprises a bearing support and a roller ball bearing assembly supported by the bearing support. The roller ball bearing assembly comprises a rotatable ball. The rotatable balls of the roller ball bearing assemblies are positioned to collectively support a bowling ball in a rotational manner. The plurality of link assemblies are configured to be disassembled for storage and reassembled without tools in a puzzle-like manner.

According to other aspects of the present disclosure, the bowling ball support assembly may include one or more of the following features. The plurality of link assemblies may be arranged in a pentagonal configuration. The rotatable balls of the roller ball bearing assemblies may be equally spaced around the bowling ball support assembly to maintain sufficient contact points to prevent slippage of the bowling ball into a finger hole. Each link assembly may comprise a first angled end and a second angled end, the first angled end comprising a first angled end flat surface and the second angled end comprising a second angled end flat surface. Adjacent link assemblies may be connected at their respective angled ends to form the radial configuration. Each link assembly may comprise a bottom surface, and the bottom surfaces of the plurality of link assemblies may be coplanar to form a uniform flat base when the plurality of link assemblies are arranged in the radial configuration. At least one link assembly of the plurality of link assemblies may comprise a recessed connection portion at one end and a protrusion connection portion at an opposite end. The recessed connection portion may comprise a connection shoulder configured to function as a stop for engaging with an adjacent link assembly, and the protrusion connection portion may comprise a connection interface channel configured to receive the connection shoulder of an adjacent link assembly. The protrusion connection portion may comprise an outward extending portion and an upward extending portion. At least one link assembly of the plurality of link assemblies may comprise a first protrusion connection portion at one end and a second protrusion connection portion at an opposite end. At least one link assembly of the plurality of link assemblies may comprise a first recessed connection portion at one end and a second recessed connection portion at an opposite end. The bearing support may comprise a bearing assembly seat configured to receive the roller ball bearing assembly. The roller ball bearing assembly may comprise a cylindrical housing with an outer flange, the outer flange configured to rest upon the bearing assembly seat. The bearing support may be oriented at an angle relative to horizontal to position the rotatable ball toward a center of the bowling ball support assembly. The plurality of link assemblies may comprise a primary link assembly comprising a recessed connection portion at one end and a protrusion connection portion at an opposite end, a protrusion link assembly comprising protrusion connection portions at both ends, and a recessed link assembly comprising recessed connection portions at both ends.

According to another aspect of the present disclosure, a bowling ball support kit is provided. The bowling ball support kit comprises a plurality of link assemblies configured to be arranged in a radial configuration. Each link assembly comprises a bearing support comprising a bearing assembly seat and a roller ball bearing assembly received within the bearing assembly seat. The roller ball bearing assembly comprises a rotatable ball extending above the bearing support. Each link assembly comprises a first angled end and a second angled end. Adjacent link assemblies are connectable at their respective angled ends through interlocking connection portions. The rotatable balls are positioned to collectively support a bowling ball when the plurality of link assemblies are arranged in the radial configuration. The plurality of link assemblies are configured to be stored in a disassembled state and reassembled without tools in a puzzle-like manner.

According to other aspects of the present disclosure, the bowling ball support kit may include one or more of the following features. The interlocking connection portions may comprise protrusion connection portions and recessed connection portions configured to engage with one another. Each protrusion connection portion may comprise a connection interface channel and each recessed connection portion may comprise a connection shoulder, the connection shoulder configured to be received within the connection interface channel of an adjacent link assembly. The plurality of link assemblies may be configured to remain connected through friction when the bowling ball support kit is lifted.

According to another aspect of the present disclosure, a bowling ball support assembly is provided. The bowling ball support assembly comprises a plurality of link assemblies arranged in a pentagonal configuration. Each link assembly comprises a bearing support oriented at an angle relative to horizontal and a roller ball bearing assembly supported by the bearing support. The roller ball bearing assembly comprises a rotatable ball. Each link assembly comprises connection portions at opposite ends configured to interlock with connection portions of adjacent link assemblies. The rotatable balls are positioned to collectively support a bowling ball in a rotational manner. The plurality of link assemblies are configured to be disassembled for storage and reassembled without tools in a puzzle-like manner.

According to other aspects of the present disclosure, the bowling ball support assembly may include one or more of the following features. The plurality of link assemblies may comprise three primary link assemblies each having a recessed connection portion at one end and a protrusion connection portion at an opposite end, one protrusion link assembly having protrusion connection portions at both ends, and one recessed link assembly having recessed connection portions at both ends.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a top perspective view of a bowling ball support assembly, according to aspects of the present disclosure.

FIG. 2 illustrates a bottom perspective view of the bowling ball support assembly of FIG. 1, according to aspects of the present disclosure.

FIG. 3 illustrates an exploded view of a bearing support and a roller ball bearing assembly, according to aspects of the present disclosure.

FIG. 4 illustrates a top perspective view of the bowling ball support assembly without seated roller ball bearing assemblies, according to aspects of the present disclosure.

FIG. 5 illustrates a side perspective view of the bowling ball support assembly with a bowling ball positioned above, according to aspects of the present disclosure.

FIG. 6 illustrates a top plan view of the bowling ball support assembly in an assembled configuration, according to aspects of the present disclosure.

FIG. 7 illustrates an elevation view of the bowling ball support assembly, according to aspects of the present disclosure.

FIG. 8 illustrates a sectional elevation view of a portion of the bowling ball support assembly, according to aspects of the present disclosure.

FIG. 9 illustrates a top perspective view of a primary link assembly, according to aspects of the present disclosure.

FIG. 10 illustrates a bottom perspective view of the primary link assembly of FIG. 9, according to aspects of the present disclosure.

FIG. 11 illustrates an interior elevation view of the primary link assembly of FIG. 9, according to aspects of the present disclosure.

FIG. 12 illustrates a top plan view of the primary link assembly of FIG. 9, according to aspects of the present disclosure.

FIG. 13 illustrates a bottom plan view of the primary link assembly of FIG. 9, according to aspects of the present disclosure.

FIG. 14 illustrates a top perspective view of a protrusion link assembly, according to aspects of the present disclosure.

FIG. 15 illustrates a bottom perspective view of the protrusion link assembly of FIG. 14, according to aspects of the present disclosure.

FIG. 16 illustrates an interior elevation view of the protrusion link assembly of FIG. 14, according to aspects of the present disclosure.

FIG. 17 illustrates a top plan view of the protrusion link assembly of FIG. 14, according to aspects of the present disclosure.

FIG. 18 illustrates a bottom plan view of the protrusion link assembly of FIG. 14, according to aspects of the present disclosure.

FIG. 19 illustrates a top perspective view of a recessed link assembly, according to aspects of the present disclosure.

FIG. 20 illustrates a bottom perspective view of the recessed link assembly of FIG. 19, according to aspects of the present disclosure.

FIG. 21 illustrates an interior elevation view of the recessed link assembly of FIG. 19 according to aspects of the present disclosure.

FIG. 22 illustrates a top plan view of the recessed link assembly of FIG. 19, according to aspects of the present disclosure.

FIG. 23 illustrates a bottom plan view of the recessed link assembly of FIG. 19, according to aspects of the present disclosure.

FIG. 24 illustrates an exploded, unassembled view of the bowling ball support assembly, according to aspects of the present disclosure.

FIG. 25 illustrates a bottom plan view of the bowling ball support assembly in an assembled configuration, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure describes a bowling ball support assembly. The bowling ball support assembly may also be referred to as a bowling ball support kit. The bowling ball support assembly may be configured as a portable device that addresses the challenge of conveniently storing and transporting a bowling ball support cup in a typical bowling bag. In some aspects, the bowling ball support assembly may provide a stable platform for a bowling ball while allowing the bowling ball to rotate freely, enabling easier access to all areas of the bowling ball surface for cleaning, polishing, or inspection purposes.

In some cases, the bowling ball support assembly may comprise a plurality of link assemblies that can be disassembled for storage and reassembled without tools. The link assemblies may be configured to connect together in a puzzle-like manner, forming a radial structure capable of supporting a bowling ball in a rotational manner. This configuration may allow the bowling ball support assembly to be broken down into individual link assemblies that can be stored separately, reducing the overall footprint of the bowling ball support assembly when not in use and facilitating transportation in a bowling bag alongside a bowling ball and other bowling equipment.

In some aspects, each link assembly may include a bearing support and a roller ball bearing assembly. The roller ball bearing assemblies may each comprise a rotatable ball positioned to contact and support a bowling ball. When the link assemblies are arranged in the radial configuration, the rotatable balls may be positioned to collectively support the bowling ball while allowing the bowling ball to rotate smoothly in any direction. This rotational capability may facilitate various maintenance activities such as cleaning, polishing, or inspecting the bowling ball surface.

The tool-free assembly and disassembly feature of the bowling ball support assembly may provide convenience for bowlers who wish to maintain their bowling balls at various locations, including bowling alleys, homes, or during travel. The link assemblies may be configured to interlock through complementary connection portions, allowing the bowling ball support assembly to be assembled and disassembled intuitively without requiring additional hardware or fasteners.

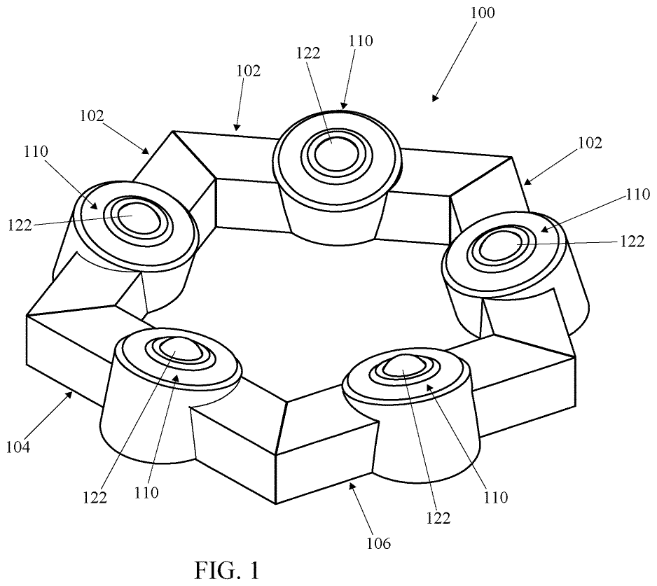

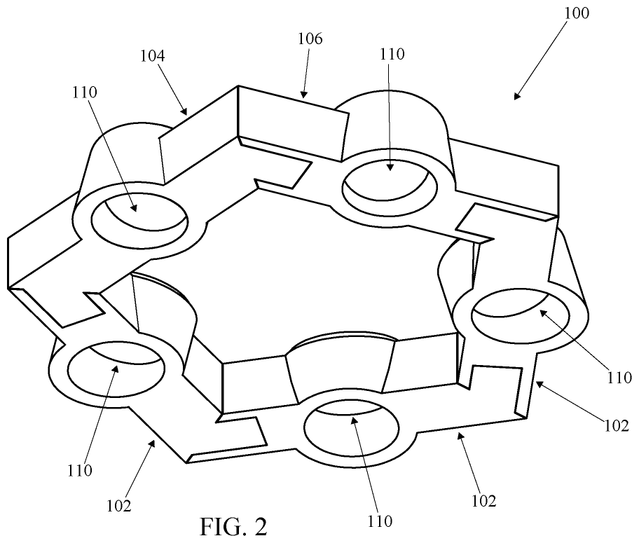

FIG. 1 illustrates a top perspective view of a bowling ball support assembly 100, and FIG. 2 illustrates a bottom perspective view of the bowling ball support assembly 100. The bowling ball support assembly 100 may comprise a plurality of link assemblies configured to be arranged in a radial configuration. In some aspects, the plurality of link assemblies may be arranged in a pentagonal configuration, as shown in FIG. 1 and FIG. 2.

The plurality of link assemblies may comprise a primary link assembly 102, a protrusion link assembly 104, and a recessed link assembly 106. In some cases, the bowling ball support assembly 100 may comprise three primary link assemblies 102, one protrusion link assembly 104, and one recessed link assembly 106 arranged in the pentagonal configuration. The primary link assembly 102 may comprise a recessed connection portion at one end and a protrusion connection portion at an opposite end. The protrusion link assembly 104 may comprise protrusion connection portions at both ends. The recessed link assembly 106 may comprise recessed connection portions at both ends.

Each link assembly may comprise connection portions at opposite ends configured to interlock with connection portions of adjacent link assemblies. The link assemblies may be connected to one another through the interlocking connection portions at angled ends of the link assemblies, forming a continuous pentagonal structure. The protrusion connection portions of the primary link assemblies 102 and the protrusion link assembly 104 may engage with the recessed connection portions of adjacent link assemblies to form the radial configuration.

Each link assembly may comprise a bearing support and a roller ball bearing assembly 110 supported by the bearing support. Each roller ball bearing assembly 110 may comprise a rotatable ball 122. As shown in FIG. 1 and FIG. 2, the roller ball bearing assemblies 110 may be positioned at regular intervals around the pentagonal structure, with each roller ball bearing assembly 110 including a ball 122 extending above the roller ball bearing assembly 110.

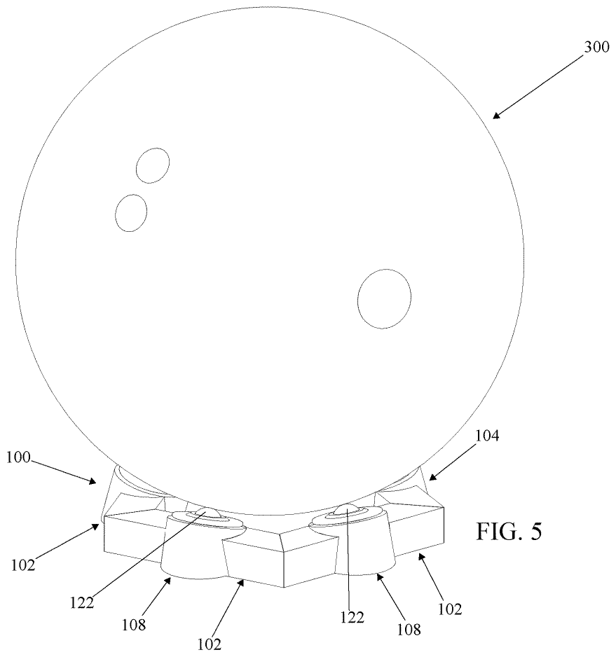

FIG. 5 illustrates a side perspective view of the bowling ball support assembly 100 with a bowling ball 300 positioned above the bowling ball support assembly 100. The rotatable balls 122 of the roller ball bearing assemblies 110 may be positioned at intervals to collectively support the bowling ball 300 in a rotational manner. The arrangement of the rotatable balls 122 around the perimeter of the bowling ball support assembly 100 may provide multiple contact points that distribute the weight of the bowling ball 300 evenly across the structure when in use, allowing smooth rotation of the bowling ball 300.

The plurality of link assemblies may be configured to be disassembled for storage and reassembled without tools. The link assemblies may be configured to connect together in a puzzle-like manner, with the connection portions of adjacent link assemblies engaging to maintain structural integrity through friction when the bowling ball support assembly 100 is lifted. This configuration may allow the bowling ball support assembly 100 to be broken down into individual link assemblies that can be stored separately, reducing the overall footprint of the bowling ball support assembly 100 when not in use and facilitating transportation in a bowling bag.

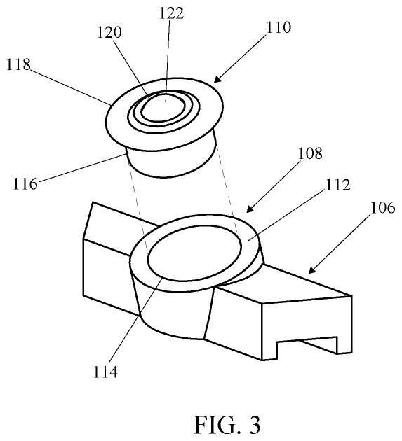

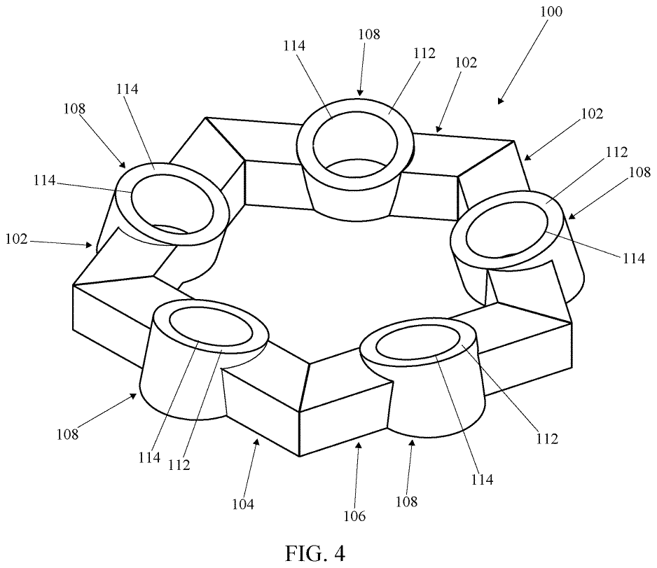

FIG. 3 illustrates an exploded view of a bearing support 108 and a roller ball bearing assembly 110 of the bowling ball support assembly 100. FIG. 4 illustrates a top perspective view of the bowling ball support assembly 100 without seated roller ball bearing assemblies 110, showing the bearing support 108 of the link assemblies.

Each link assembly may comprise a bearing support 108 and a roller ball bearing assembly 110 supported by the bearing support 108. The bearing support 108 may include a bearing support top surface 112 and a bearing assembly seat 114. The bearing assembly seat 114 may be configured to receive the roller ball bearing assembly 110. In some aspects, the bearing assembly seat 114 may be formed as a recessed area within the bearing support 108 sized to accommodate the roller ball bearing assembly 110.

The roller ball bearing assembly 110 may comprise a cylindrical housing 116 with an outer flange 118. The outer flange 118 may extend radially outward from a top portion of the cylindrical housing 116. The outer flange 118 may be configured to rest upon the bearing assembly seat 114 of the bearing support 108 when the roller ball bearing assembly 110 is installed. In some aspects, the outer flange 118 may seat upon and be supported by the bearing assembly seat 114, with the bearing assembly seat 114 providing a stable mounting surface that receives and supports the outer flange 118. This seating arrangement may position the roller ball bearing assembly 110 at a consistent height relative to the bearing support 108 and may help maintain the roller ball bearing assembly 110 in a desired orientation. In some cases, the outer flange 118 may contact and rest onto the bearing support top surface 112 of the bearing support 108 adjacent to the bearing assembly seat 114, providing a stable seating arrangement for the roller ball bearing assembly 110.

The roller ball bearing assembly 110 may be retained within the bearing assembly seat 114 by way of a friction fit. The dimensions of the bearing assembly seat 114 and the cylindrical housing 116 may be configured to provide sufficient friction between the mating surfaces to secure the roller ball bearing assembly 110 in position during use while still allowing the roller ball bearing assembly 110 to be removed without tools when disassembly is desired.

The roller ball bearing assembly 110 may further comprise a ball seat 120 positioned within the cylindrical housing 116. The ball seat 120 may be configured to rotatably support a rotatable ball 122. The rotatable ball 122 may extend above the bearing support 108 and above the cylindrical housing 116. The rotatable ball 122 may provide a contact surface for supporting and rotating a bowling ball when the bowling ball support assembly 100 is in use.

As described previously, each link assembly of the plurality of link assemblies may comprise a bearing support 108 comprising a bearing assembly seat 114 and a roller ball bearing assembly 110 received within the bearing assembly seat 114. The roller ball bearing assembly 110 may comprise a rotatable ball 122 extending above the bearing support 108. When the plurality of link assemblies are arranged in the radial configuration, the rotatable balls 122 of the roller ball bearing assemblies 110 may be positioned to collectively support a bowling ball in a rotational manner.

In some aspects, the roller ball bearing assemblies 110 may be designed to allow for interchangeability of bearing types. The bearings utilized in the roller ball bearing assemblies 110 may be standard items that can be purchased at a general hardware store or online retailer. This interchangeability may provide flexibility in customizing the bowling ball support assembly 100 for different usage scenarios or user preferences.

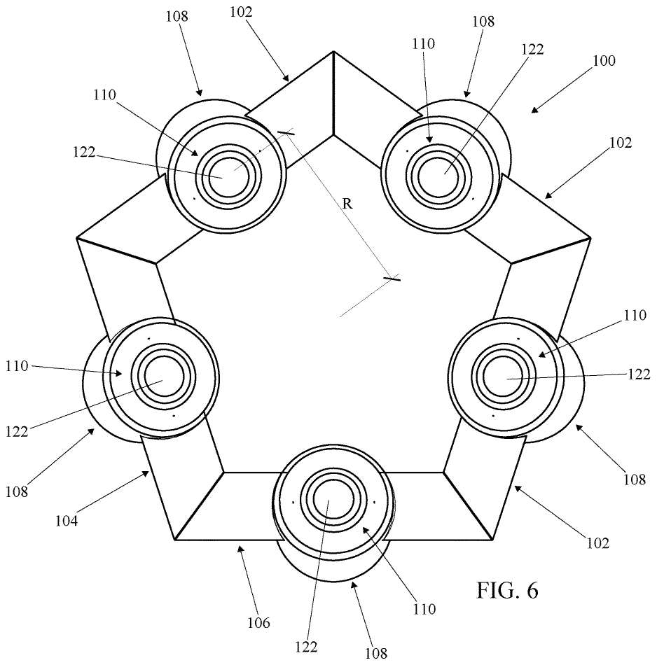

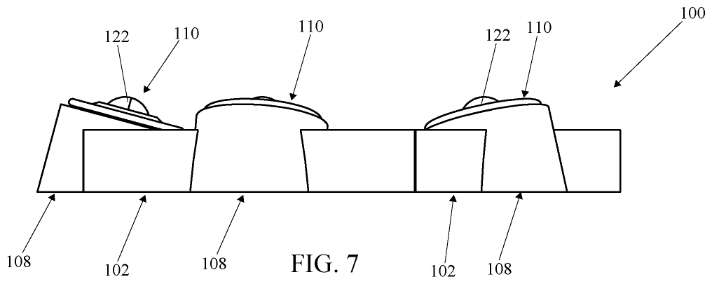

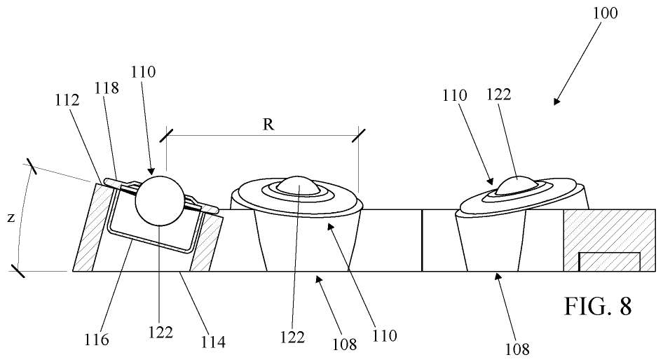

FIG. 6 illustrates a top plan view of the bowling ball support assembly 100 in an assembled configuration, and FIG. 7 illustrates an elevation view of the bowling ball support assembly 100. FIG. 8 illustrates a sectional elevation view of a portion of the bowling ball support assembly 100, showing the relationship between the bearing support 108 and the roller ball bearing assembly 110.

As described previously, each link assembly of the plurality of link assemblies may comprise a bearing support 108 and a roller ball bearing assembly 110 supported by the bearing support 108. The roller ball bearing assembly 110 may comprise a rotatable ball 122 extending above the bearing support 108. The bearing support 108 may be oriented at an angle relative to horizontal to position the rotatable ball 122 toward a center of the bowling ball support assembly 100. In some aspects, the bearing support 108 as a structural component may be positioned such that its bearing support top surface 112 is angled inward, directing the roller ball bearing assembly 110 and the rotatable ball 122 toward the center of the bowling ball support assembly 100 for optimal contact with a bowling ball.

The angled orientation of the bearing support 108 may position the roller ball bearing assembly 110 at an inward angle relative to the perimeter of the bowling ball support assembly 100. This inward angling of the bearing support 108 may direct the rotatable ball 122 toward the center of the bowling ball support assembly 100, where a bowling ball would be positioned during use. When the plurality of link assemblies are arranged in the radial configuration, the collectively inward-angled bearing supports 108 may define a concave support region that accommodates the spherical curvature of a bowling ball. The inward orientation of each bearing support 108 may allow the rotatable balls 122 to contact the bowling ball at positions along its curved surface rather than at tangential points, which may provide more stable support and facilitate smoother rotation of the bowling ball.

In some aspects, the bearing support 108 may be oriented at an angle R from horizontal, as shown in FIG. 8. In some aspects, the angle R may be approximately 15 degrees from horizontal. In other aspects, the angle R may be within a range of approximately 10 degrees to approximately 20 degrees from horizontal. In some cases, the angle R may be within a range of approximately 5 degrees to approximately 30 degrees from horizontal. The angled orientation of the bearing support 108 may direct the roller ball bearing assembly 110 inward toward the center of the bowling ball support assembly 100. This angled orientation of the bearing support 108 relative to horizontal may position the rotatable ball 122 to provide optimal contact points for supporting and rotating a bowling ball.

When the plurality of link assemblies are arranged in the radial configuration, the angled orientation of the bearing supports 108 may position the rotatable balls 122 of the roller ball bearing assemblies 110 to collectively support a bowling ball in a rotational manner. The inward orientation of the roller ball bearing assemblies 110 may provide contact points that are directed toward the center of the bowling ball support assembly 100, where a bowling ball may be positioned. This arrangement may distribute the weight of the bowling ball across the rotatable balls 122 and may allow for smooth rotation of the bowling ball in any direction.

Each link assembly may comprise a top surface and a bottom surface. As shown in FIG. 7, the bottom surfaces of the plurality of link assemblies may be coplanar to form a uniform flat base when the plurality of link assemblies are arranged in the radial configuration. The coplanar arrangement of the bottom surfaces may provide a stable foundation for the bowling ball support assembly 100 when placed on a flat surface. The uniform flat base formed by the coplanar bottom surfaces may allow the bowling ball support assembly 100 to rest evenly on a supporting surface, which may contribute to the stability of the bowling ball support assembly 100 during use.

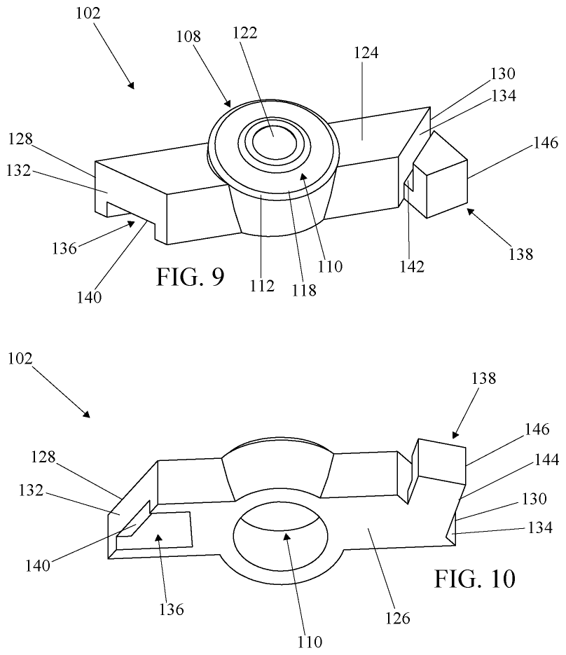

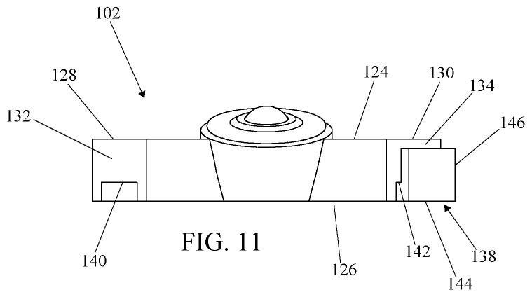

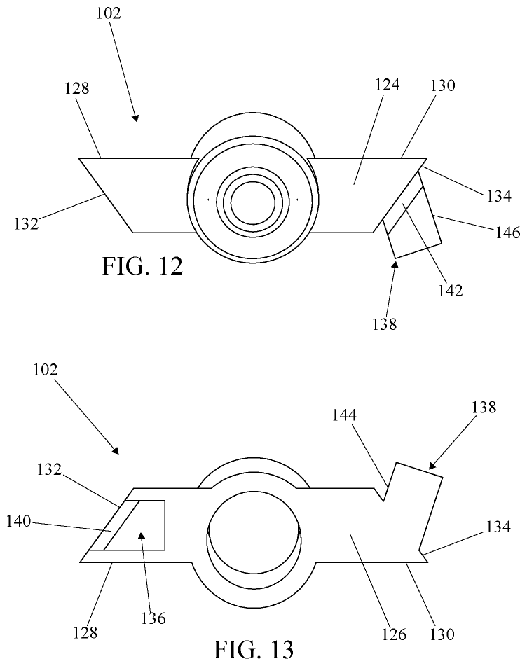

FIG. 9 and FIG. 10 illustrate top and bottom perspective views of the primary link assembly 102, and FIG. 11 illustrates an interior elevation view of the primary link assembly 102. FIG. 12 and FIG. 13 illustrate top and bottom plan views of the primary link assembly 102. As described previously, the bowling ball support assembly 100 may comprise a plurality of link assemblies, including the primary link assembly 102. Each link assembly may comprise a first angled end and a second angled end. The primary link assembly 102 may comprise a primary link top surface 124 and a bottom surface 126. The primary link assembly 102 may comprise a first angled end 128 positioned at one side and a second angled end 130 positioned at an opposite side. The first angled end 128 may comprise a first angled end flat surface 132, and the second angled end 130 may comprise a second angled end flat surface 134. The first angled end flat surface 132 and the second angled end flat surface 134 may be configured to mate with corresponding angled end flat surfaces of adjacent link assemblies when the bowling ball support assembly 100 is arranged in the radial configuration.

In some aspects, the angled ends of the link assemblies may be configured to form a specific polygonal shape when assembled. For example, when the plurality of link assemblies are arranged in the pentagonal configuration, the first angled end flat surface 132 and the second angled end flat surface 134 may each extend at an angle relative to the body of the primary link assembly 102 to achieve the pentagonal arrangement. In the pentagonal configuration, the angled ends may be oriented at reciprocal 54 degree angles extending inward to form the five-sided radial structure. These reciprocal 54 degree angles at each angled end may allow adjacent link assemblies to mate flush when connected, with the combined angles at each junction contributing to the overall pentagonal geometry of the bowling ball support assembly 100.

The primary link assembly 102 may comprise a recessed connection portion 136 at one end and a protrusion connection portion 138 at an opposite end. In some aspects, the recessed connection portion 136 may be positioned at the first angled end 128, and the protrusion connection portion 138 may be positioned at the second angled end 130.

The recessed connection portion 136 may provide a space configured to receive a corresponding protrusion connection portion from an adjacent link assembly. The recessed connection portion 136 may comprise a connection shoulder 140 that functions as a stop or seat for engaging with an adjacent link assembly when the bowling ball support assembly 100 is assembled. The connection shoulder 140 may be configured to rest within a connection interface channel of an adjacent link assembly having a protrusion connection portion.

The protrusion connection portion 138 may extend from the body of the primary link assembly 102. The protrusion connection portion 138 may comprise an outward extending portion 144 and an upward extending portion 146. The outward extending portion 144 may extend away from the body of the primary link assembly 102, and the upward extending portion 146 may extend in an upward direction to form a block-like structure. The protrusion connection portion 138 may further comprise a connection interface channel 142 formed between the protrusion connection portion 138 and an adjacent wall or second angled end flat surface 134 of the primary link assembly 102. The connection interface channel 142 may be configured to receive a connection shoulder from an adjacent link assembly when the bowling ball support assembly 100 is assembled.

The configuration of the recessed connection portion 136 at the first angled end 128 and the protrusion connection portion 138 at the second angled end 130 may enable the primary link assembly 102 to interlock with adjacent link assemblies in a puzzle-like manner without requiring tools for assembly or disassembly. The complementary connection portions at opposite ends of the primary link assembly 102 may allow the primary link assembly 102 to connect with link assemblies having at least one protrusion connection portion at one end and link assemblies having at least one recessed connection portion at the other end.

As described previously, the recessed connection portion 136 may comprise the connection shoulder 140. The connection shoulder 140 may function as a stop or seat for engaging with an adjacent link assembly when the bowling ball support assembly 100 is assembled. In some aspects, the connection shoulder 140 may be configured to be received within the connection interface channel of an adjacent link assembly having a protrusion connection portion. The connection shoulder 140 may extend from the body of the primary link assembly 102 at the first angled end 128 and may be sized to fit within the connection interface channel 142 of an adjacent link assembly.

As described previously, the protrusion connection portion 138 may comprise the outward extending portion 144 and the upward extending portion 146. The outward extending portion 144 may extend away from the body of the primary link assembly 102 in a direction toward an adjacent link assembly. The upward extending portion 146 may extend in an upward direction from the outward extending portion 144 to form a block-like structure. In some cases, the outward extending portion 144 and the upward extending portion 146 may be integrally formed as a single component of the protrusion connection portion 138.

The protrusion connection portion 138 may further comprise the connection interface channel 142. The connection interface channel 142 may be formed between the protrusion connection portion 138 and an adjacent wall of the primary link assembly 102. In some aspects, the connection interface channel 142 may be configured to receive the connection shoulder of an adjacent link assembly when the bowling ball support assembly 100 is assembled. The connection interface channel 142 may be sized to accommodate the connection shoulder 140 of an adjacent link assembly having a recessed connection portion 136.

The interlocking connection portions may comprise protrusion connection portions and recessed connection portions configured to engage with one another. When the bowling ball support assembly 100 is assembled, the protrusion connection portion 138 of the primary link assembly 102 may engage with a recessed connection portion of an adjacent link assembly. The connection shoulder 140 of the recessed connection portion 136 may be received within the connection interface channel 142 of an adjacent link assembly having a protrusion connection portion. This engagement between the connection shoulder 140 and the connection interface channel 142 may provide a secure connection between adjacent link assemblies while allowing for tool-free assembly and disassembly.

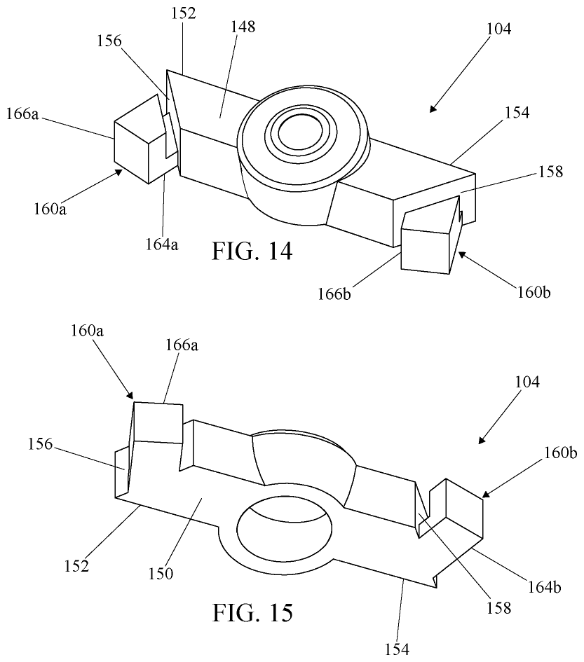

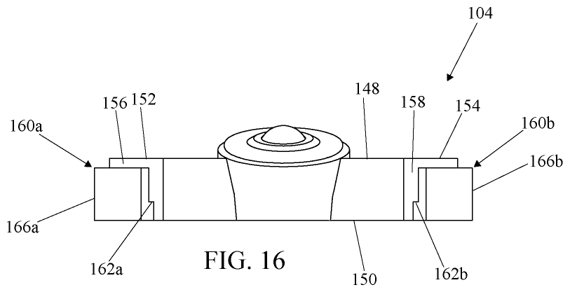

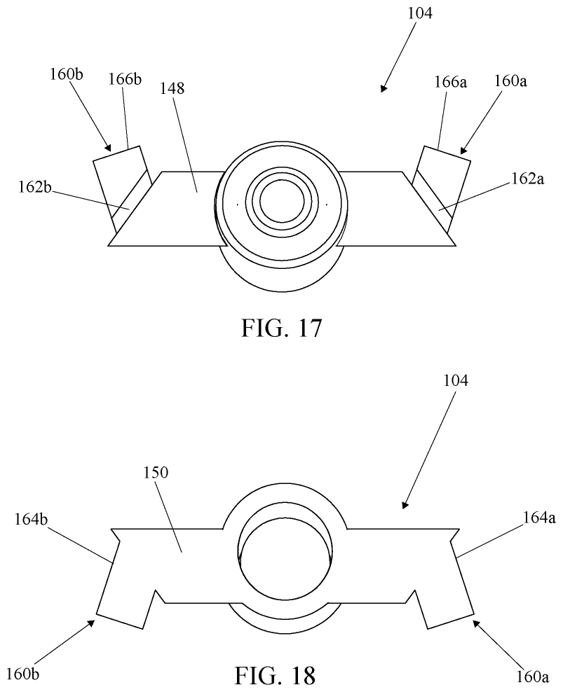

FIG. 14 and FIG. 15 illustrate top and bottom perspective views of the protrusion link assembly 104, and FIG. 16 illustrates an interior elevation view of the protrusion link assembly 104. FIG. 17 and FIG. 18 illustrate top and bottom plan views of the protrusion link assembly 104.

As described previously, the bowling ball support assembly 100 may comprise a plurality of link assemblies, including the protrusion link assembly 104. The protrusion link assembly 104 may comprise a protrusion link assembly top surface 148 and a bottom surface 150. The protrusion link assembly 104 may comprise a first angled end 152 positioned at one side and a second angled end 154 positioned at an opposite side. The first angled end 152 may comprise a first angled end flat surface 156, and the second angled end 154 may comprise a second angled end flat surface 158. The first angled end flat surface 156 and the second angled end flat surface 158 may be configured to mate with corresponding angled end flat surfaces of adjacent link assemblies when the bowling ball support assembly 100 is arranged in the radial configuration.

In some aspects, the angled ends of the protrusion link assembly 104 may be configured to form a specific polygonal shape when assembled with adjacent link assemblies. For example, when the plurality of link assemblies are arranged in the pentagonal configuration, the first angled end flat surface 156 and the second angled end flat surface 158 may each extend at an angle relative to the body of the protrusion link assembly 104 to achieve the pentagonal arrangement. In the pentagonal configuration, the angled ends may be oriented at reciprocal 54 degree angles extending inward to form the five-sided radial structure. These reciprocal 54 degree angles at each angled end may allow the protrusion link assembly 104 to mate flush with adjacent link assemblies when connected, with the combined angles at each junction contributing to the overall pentagonal geometry of the bowling ball support assembly 100.

The protrusion link assembly 104 may comprise a first protrusion connection portion 160a at one end and a second protrusion connection portion 160b at an opposite end. In some aspects, the first protrusion connection portion 160a may be positioned at the first angled end 152, and the second protrusion connection portion 160b may be positioned at the second angled end 154. This configuration of protrusion connection portions at both ends distinguishes the protrusion link assembly 104 from the primary link assembly 102, which comprises a recessed connection portion at one end and a protrusion connection portion at an opposite end.

The first protrusion connection portion 160a may extend from the body of the protrusion link assembly 104. The first protrusion connection portion 160a may comprise a first outward extending portion 164a and a first upward extending portion 166a. The first outward extending portion 164a may extend away from the body of the protrusion link assembly 104 in a direction toward an adjacent link assembly. The first upward extending portion 166a may extend in an upward direction from the first outward extending portion 164a to form a block-like structure. In some cases, the first outward extending portion 164a and the first upward extending portion 166a may be integrally formed as a single component of the first protrusion connection portion 160a.

The first protrusion connection portion 160a may further comprise a first connection interface channel 162a. The first connection interface channel 162a may be formed between the first protrusion connection portion 160a and an adjacent wall of the protrusion link assembly 104. The first connection interface channel 162a may be configured to receive a connection shoulder from an adjacent link assembly when the bowling ball support assembly 100 is assembled. The first connection interface channel 162a may be sized to accommodate the connection shoulder of an adjacent link assembly having a recessed connection portion.

The second protrusion connection portion 160b may extend from the body of the protrusion link assembly 104 at the second angled end 154. The second protrusion connection portion 160b may comprise a second outward extending portion 164b and a second upward extending portion 166b. The second outward extending portion 164b may extend away from the body of the protrusion link assembly 104 in a direction toward an adjacent link assembly. The second upward extending portion 166b may extend in an upward direction from the second outward extending portion 164b to form a block-like structure. In some cases, the second outward extending portion 164b and the second upward extending portion 166b may be integrally formed as a single component of the second protrusion connection portion 160b.

The second protrusion connection portion 160b may further comprise a second connection interface channel 162b. The second connection interface channel 162b may be formed between the second protrusion connection portion 160b and an adjacent wall of the protrusion link assembly 104. The second connection interface channel 162b may be configured to receive a connection shoulder from an adjacent link assembly when the bowling ball support assembly 100 is assembled. The second connection interface channel 162b may be sized to accommodate the connection shoulder of an adjacent link assembly having a recessed connection portion.

The configuration of the first protrusion connection portion 160a at the first angled end 152 and the second protrusion connection portion 160b at the second angled end 154 may enable the protrusion link assembly 104 to interlock with adjacent link assemblies in a puzzle-like manner without requiring tools for assembly or disassembly. The protrusion connection portions 160a, 160b at both ends of the protrusion link assembly 104 may allow the protrusion link assembly 104 to connect with link assemblies having at least one recessed connection portion at each adjacent end.

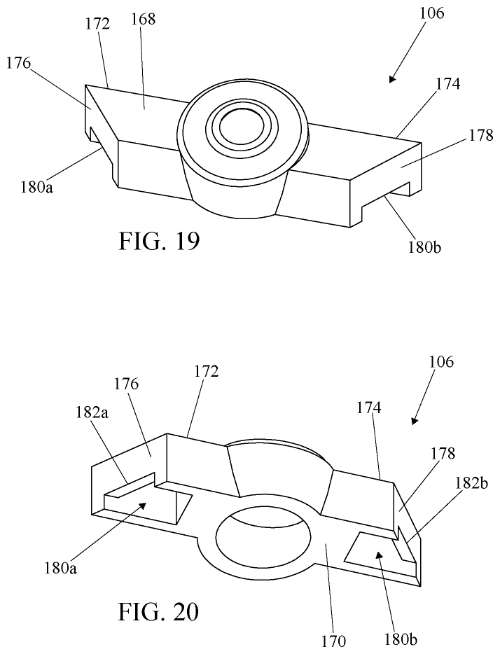

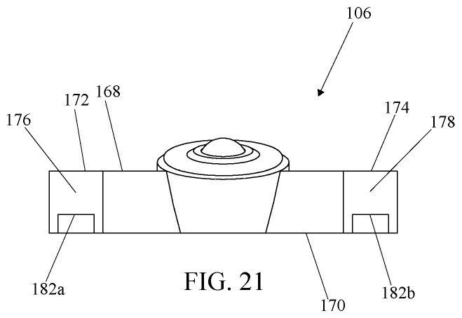

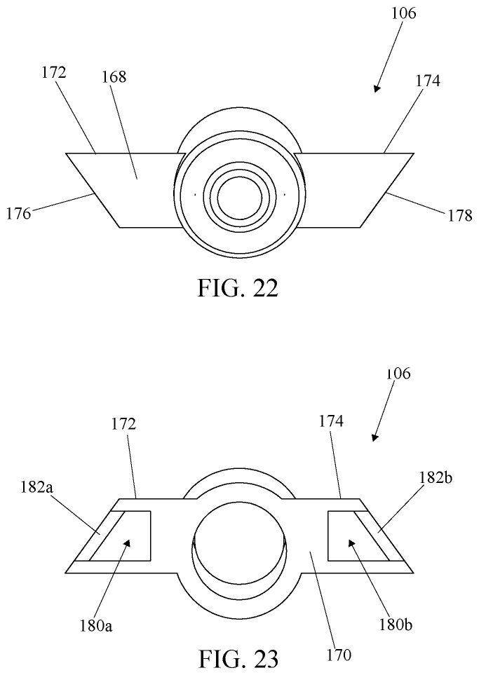

FIG. 19 and FIG. 20 illustrate top and bottom perspective views of the recessed link assembly 106, and FIG. 21 illustrates an interior elevation view of the recessed link assembly 106. FIG. 22 and FIG. 23 illustrate top and bottom plan views of the recessed link assembly 106.

As described previously, the bowling ball support assembly 100 may comprise a plurality of link assemblies, including the recessed link assembly 106. The recessed link assembly 106 may comprise a recessed link assembly top surface 168 and a bottom surface 170. The recessed link assembly 106 may comprise a first angled end 172 positioned at one side and a second angled end 174 positioned at an opposite side. The first angled end 172 may comprise a first angled end flat surface 176, and the second angled end 174 may comprise a second angled end flat surface 178. The first angled end flat surface 176 and the second angled end flat surface 178 may be configured to mate with corresponding angled end flat surfaces of adjacent link assemblies when the bowling ball support assembly 100 is arranged in the radial configuration.

In some aspects, the angled ends of the recessed link assembly 106 may be configured to form a specific polygonal shape when assembled with adjacent link assemblies. For example, when the plurality of link assemblies are arranged in the pentagonal configuration, the first angled end flat surface 176 and the second angled end flat surface 178 may each extend at an angle relative to the body of the recessed link assembly 106 to achieve the pentagonal arrangement. In the pentagonal configuration, the angled ends may be oriented at reciprocal 54 degree angles extending inward to form the five-sided radial structure. These reciprocal 54 degree angles at each angled end may allow the recessed link assembly 106 to mate flush with adjacent link assemblies when connected, with the combined angles at each junction contributing to the overall pentagonal geometry of the bowling ball support assembly 100.

The recessed link assembly 106 may comprise a first recessed connection portion 180a at one end and a second recessed connection portion 180b at an opposite end. In some aspects, the first recessed connection portion 180a may be positioned at the first angled end 172, and the second recessed connection portion 180b may be positioned at the second angled end 174. This configuration of recessed connection portions at both ends distinguishes the recessed link assembly 106 from the primary link assembly 102, which comprises a recessed connection portion at one end and a protrusion connection portion at an opposite end.

The first recessed connection portion 180a may provide a space configured to receive a corresponding protrusion connection portion from an adjacent link assembly. The first recessed connection portion 180a may comprise a first connection shoulder 182a. The first connection shoulder 182a may function as a stop or seat for engaging with an adjacent link assembly when the bowling ball support assembly 100 is assembled. The first connection shoulder 182a may be configured to be received within a connection interface channel of an adjacent link assembly having a protrusion connection portion.

The second recessed connection portion 180b may provide a space configured to receive a corresponding protrusion connection portion from an adjacent link assembly at the second angled end 174. The second recessed connection portion 180b may comprise a second connection shoulder 182b. The second connection shoulder 182b may function as a stop or seat for engaging with an adjacent link assembly when the bowling ball support assembly 100 is assembled. The second connection shoulder 182b may be configured to be received within a connection interface channel of an adjacent link assembly having a protrusion connection portion.

The configuration of the first recessed connection portion 180a at the first angled end 172 and the second recessed connection portion 180b at the second angled end 174 may enable the recessed link assembly 106 to interlock with adjacent link assemblies in a puzzle-like manner without requiring tools for assembly or disassembly. The recessed connection portions 180a, 180b at both ends of the recessed link assembly 106 may allow the recessed link assembly 106 to connect with link assemblies having at least one protrusion connection portion at each adjacent end.

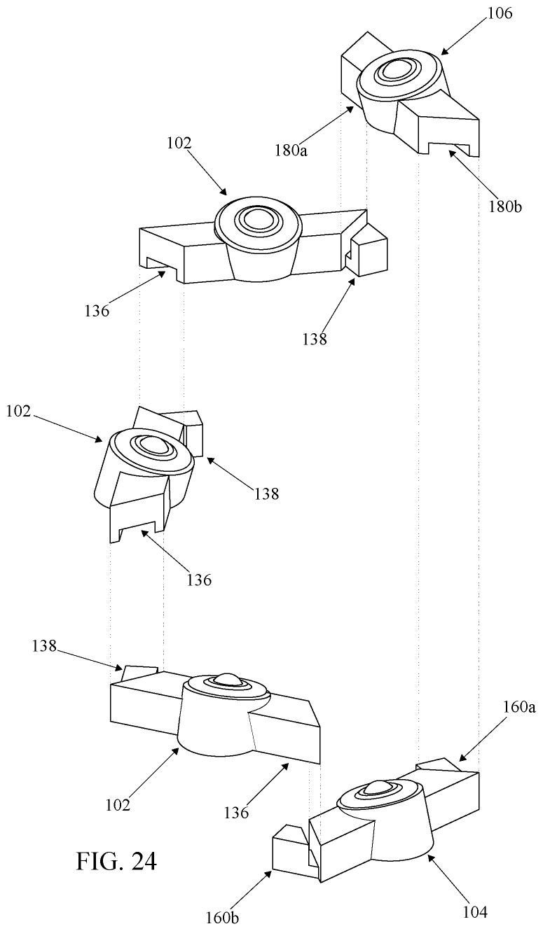

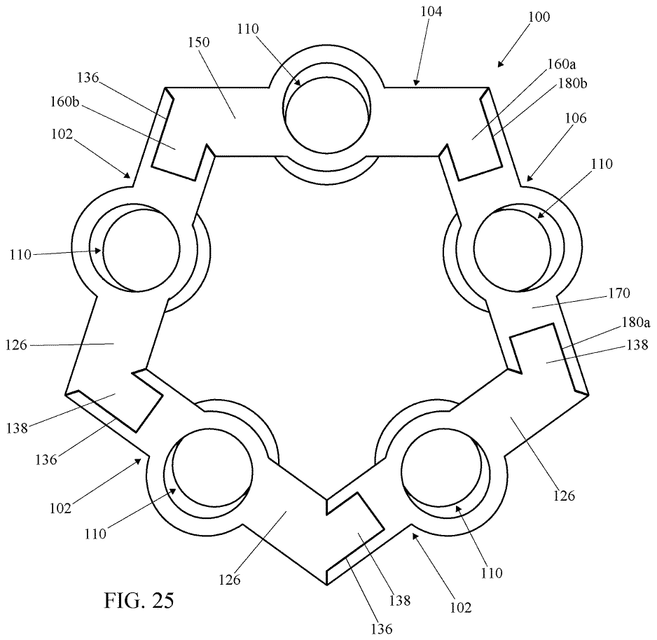

FIG. 24 illustrates an exploded view of the bowling ball support assembly 100, and FIG. 25 illustrates a bottom plan view of the bowling ball support assembly 100 in an assembled configuration. As described previously, the bowling ball support assembly 100 may comprise a plurality of link assemblies configured to be arranged in a radial configuration. In some aspects, the plurality of link assemblies may comprise three primary link assemblies 102, one protrusion link assembly 104, and one recessed link assembly 106 arranged in a pentagonal configuration.

As shown in FIG. 24, the plurality of link assemblies may be assembled together through interlocking connection portions at respective angled ends of the link assemblies. Adjacent link assemblies may be connected at the respective angled ends to form the radial configuration. The protrusion connection portions of the link assemblies may engage with the recessed connection portions of adjacent link assemblies to form the pentagonal structure.

In some cases, the assembly process may involve aligning the connection portions of adjacent link assemblies and bringing the link assemblies together. The protrusion connection portion 138 of a primary link assembly 102 may engage with a recessed connection portion of an adjacent link assembly. The first protrusion connection portion 160a and the second protrusion connection portion 160b of the protrusion link assembly 104 may engage with recessed connection portions of adjacent link assemblies. The first recessed connection portion 180a and the second recessed connection portion 180b of the recessed link assembly 106 may receive protrusion connection portions of adjacent link assemblies.

When the link assemblies are connected, the connection shoulders of the recessed connection portions may be received within the connection interface channels of the protrusion connection portions. The connection shoulder 140 of the recessed connection portion 136 of a primary link assembly 102 may be received within the connection interface channel of an adjacent link assembly having a protrusion connection portion. The first connection shoulder 182a and the second connection shoulder 182b of the recessed link assembly 106 may be received within the connection interface channels of adjacent link assemblies having protrusion connection portions. The first connection interface channel 162a and the second connection interface channel 162b of the protrusion link assembly 104 may receive the connection shoulders of adjacent link assemblies having recessed connection portions.

As shown in FIG. 25, when the plurality of link assemblies are assembled in the radial configuration, the interlocking connection portions may create a continuous structure. The protrusion connection portions 138, 160a, and 160b may fit together with the recessed connection portions 136, 180a, and 180b in a complementary manner. The bottom surfaces 126, 150, and 170 of the link assemblies may align to form a continuous plane, providing a stable base for the bowling ball support assembly 100.

In some aspects, a method of assembling the bowling ball support assembly 100 may comprise positioning the recessed link assembly 106 as a starting point. The method may further comprise connecting a first primary link assembly 102 to the recessed link assembly 106 by engaging the protrusion connection portion 138 of the first primary link assembly 102 with the first recessed connection portion 180a of the recessed link assembly 106. The connection shoulder 140 of the first primary link assembly 102 may be aligned with and received within the first connection interface channel of the recessed link assembly 106 during this step.

The method may further comprise connecting a second primary link assembly 102 to the first primary link assembly 102 by engaging the protrusion connection portion 138 of the second primary link assembly 102 with the recessed connection portion 136 of the first primary link assembly 102. Similarly, the method may comprise connecting a third primary link assembly 102 to the second primary link assembly 102 by engaging the protrusion connection portion 138 of the third primary link assembly 102 with the recessed connection portion 136 of the second primary link assembly 102.

The method may further comprise connecting the protrusion link assembly 104 to complete the pentagonal configuration. The first protrusion connection portion 160a of the protrusion link assembly 104 may be engaged with the second recessed connection portion 180b of the recessed link assembly 106, and the second protrusion connection portion 160b of the protrusion link assembly 104 may be engaged with the recessed connection portion 136 of the third primary link assembly 102. The first connection shoulder 182a and the second connection shoulder 182b of the recessed link assembly 106 may be received within the first connection interface channel 162a and the connection interface channel 142 of the adjacent link assemblies, respectively.

As shown in FIG. 24 and FIG. 25, the assembly process may be performed by bringing adjacent link assemblies together in a downward or lateral motion, allowing the connection shoulders to slide into the connection interface channels. The assembly process may be reversed for disassembly, with the link assemblies being separated by lifting or sliding them apart without the need for tools.

The interlocking tolerance precision of the link assemblies may allow the bowling ball support assembly 100 to remain intact through friction when the bowling ball support assembly 100 is lifted. The plurality of link assemblies may be configured to remain connected through friction when the bowling ball support assembly 100 is lifted. In some aspects, the protrusion connection portions and recessed connection portions may be sized to provide a fit that is loose enough to allow easy assembly without locking together, while being tight enough to maintain connection through friction when lifted. The connection shoulders may be sized to fit within the connection interface channels with minimal clearance, creating a friction fit between the mating surfaces. In some cases, minor deflection of the link assemblies during assembly may contribute to the friction engagement between adjacent link assemblies. The engagement between the connection shoulders and the connection interface channels may provide a secure connection between adjacent link assemblies while allowing for tool-free assembly and disassembly.

Adjacent link assemblies may be connectable at the respective angled ends through the interlocking connection portions. The angled end flat surfaces of adjacent link assemblies may mate flush at an angle to provide the pentagonal configuration. The first angled end flat surface and the second angled end flat surface of each link assembly may be configured to mate with corresponding angled end flat surfaces of adjacent link assemblies when the bowling ball support assembly 100 is arranged in the radial configuration.

When the plurality of link assemblies are arranged in the radial configuration, the rotatable balls 122 of the roller ball bearing assemblies 110 may be positioned to collectively support a bowling ball. The arrangement of the rotatable balls 122 around the perimeter of the bowling ball support assembly 100 may provide multiple contact points that distribute the weight of a bowling ball evenly across the structure when in use, allowing smooth rotation of the bowling ball.

The plurality of link assemblies may be configured to be stored in a disassembled state and reassembled without tools. The puzzle-like configuration of the connection portions may allow the bowling ball support assembly 100 to be broken down into individual link assemblies that can be stored separately, reducing the overall footprint of the bowling ball support assembly 100 when not in use and facilitating transportation in a bowling bag.

In some aspects, the bowling ball support assembly may be configured with alternative arrangements of the link assemblies. These alternative configurations may provide different structural or functional characteristics while maintaining the function of supporting a bowling ball.

In some cases, the bowling ball support assembly may comprise a plurality of link assemblies, for example, the bowling ball support assembly may comprise a different number of link assemblies arranged in an alternative radial configuration as an alternative to the pentagonal configuration. In other cases, the bowling ball support assembly may comprise four link assemblies or six link assemblies as an alternative configuration to the five-piece pentagonal arrangement. The variation in the number of link assemblies may affect the overall shape and stability of the bowling ball support assembly.

In some aspects, the connection methods between the link assemblies may be modified. While the protrusion connection portions and recessed connection portions provide one method of interlocking, alternative connection mechanisms may be employed. For instance, snap-fit connections may be used to join the link assemblies as an alternative to the interlocking protrusion and recessed connection portions. In some cases, magnetic connections may be used to join the link assemblies as an alternative to the interlocking protrusion and recessed connection portions.

In some aspects, the shape of the link assemblies may be modified. While the described aspects feature angled ends, alternative designs may incorporate curved ends. In other cases, alternative designs may incorporate straight ends. These shape variations may influence how the link assemblies fit together and the overall form of the assembled bowling ball support assembly.

In some cases, the bearings utilized in the roller ball bearing assemblies may be standard items that can be purchased at a general hardware store or online retailer. The bearing type may be interchangeable for each roller unit. This interchangeability may provide flexibility in customizing the bowling ball support assembly for different usage scenarios or user preferences.

In some aspects, the bowling ball support assembly may be constructed from materials that are durable and resistant to wear, providing longevity and reliability in diverse usage conditions.

In some cases, the bowling ball support assembly may be designed to accommodate different sizes of bowling balls, providing versatility for users with various bowling ball preferences.

In some aspects, the downward force of a bowling ball placed on the bowling ball support assembly may cause the roller ball bearing assemblies to reach an equilibrium position. This equilibrium may help distribute the weight of the bowling ball evenly across multiple contact points, contributing to stability and smooth rotation.

In some configurations, the bowling ball support assembly may comprise three identical pieces and two unique pieces. One piece of the bowling ball support assembly may be marked as the last to be inserted when assembled and the first to be removed when disassembling, simplifying the assembly and disassembly process for users.

In some aspects, the rotatable balls of the roller ball bearing assemblies may be equally spaced around the bowling ball support assembly. This equal spacing may keep the bowling ball in balance and maintain enough contact points to avoid slippage of the bowling ball into a finger hole.

In some cases, the bottom surfaces of the link assemblies may include non-slip materials or textures to enhance stability when the bowling ball support assembly is placed on various surfaces.

In some aspects, the bearing support may have a height-adjustable support platform top surface. This adjustability may allow users to modify the angle or height of the roller ball bearing assemblies to accommodate different sizes of bowling balls or user preferences.

A number of implementations have been described. Nevertheless, it will be understood that various modifications may be made without departing from the spirit and scope of the disclosure. Accordingly, other implementations are within the scope of the following claims.

1. A bowling ball support assembly, comprising:
a plurality of link assemblies configured to be arranged in a radial configuration, each link assembly comprising:
a bearing support; and
a roller ball bearing assembly supported by the bearing support, the roller ball bearing assembly comprising a rotatable ball;
wherein the rotatable balls of the roller ball bearing assemblies are positioned to collectively support a bowling ball in a rotational manner; and
wherein the plurality of link assemblies are configured to be disassembled for storage and reassembled without tools in a puzzle-like manner.

2. The bowling ball support assembly of claim 1, wherein the plurality of link assemblies are arranged in a pentagonal configuration.

3. The bowling ball support assembly of claim 1, wherein the rotatable balls of the roller ball bearing assemblies are equally spaced around the bowling ball support assembly to maintain sufficient contact points to prevent slippage of the bowling ball into a finger hole.

4. The bowling ball support assembly of claim 1, wherein each link assembly comprises a first angled end and a second angled end, the first angled end comprising a first angled end flat surface and the second angled end comprising a second angled end flat surface.

5. The bowling ball support assembly of claim 4, wherein adjacent link assemblies are connected at their respective angled ends to form the radial configuration.

6. The bowling ball support assembly of claim 1, wherein at least one link assembly of the plurality of link assemblies comprises a recessed connection portion at one end and a protrusion connection portion at an opposite end.

7. The bowling ball support assembly of claim 6, wherein the recessed connection portion comprises a connection shoulder configured to function as a stop for engaging with an adjacent link assembly, and the protrusion connection portion comprises a connection interface channel configured to receive the connection shoulder of an adjacent link assembly.

8. The bowling ball support assembly of claim 6, wherein the protrusion connection portion comprises an outward extending portion and an upward extending portion.

9. The bowling ball support assembly of claim 1, wherein at least one link assembly of the plurality of link assemblies comprises a first protrusion connection portion at one end and a second protrusion connection portion at an opposite end.

10. The bowling ball support assembly of claim 1, wherein at least one link assembly of the plurality of link assemblies comprises a first recessed connection portion at one end and a second recessed connection portion at an opposite end.

11. The bowling ball support assembly of claim 1, wherein the bearing support comprises a bearing assembly seat configured to receive the roller ball bearing assembly.

12. The bowling ball support assembly of claim 11, wherein the roller ball bearing assembly comprises a cylindrical housing with an outer flange, the outer flange configured to rest upon the bearing support.

13. The bowling ball support assembly of claim 1, wherein the bearing support is oriented at an angle relative to horizontal to position the rotatable ball toward a center of the bowling ball support assembly.

14. The bowling ball support assembly of claim 1, wherein the plurality of link assemblies comprises:
a primary link assembly comprising a recessed connection portion at one end and a protrusion connection portion at an opposite end;
a protrusion link assembly comprising protrusion connection portions at both ends; and
a recessed link assembly comprising recessed connection portions at both ends.

15. A bowling ball support kit, comprising:
a plurality of link assemblies configured to be arranged in a radial configuration, each link assembly comprising:
a bearing support comprising a bearing assembly seat; and
a roller ball bearing assembly received within the bearing assembly seat, the roller ball bearing assembly comprising a rotatable ball extending above the bearing support;
wherein each link assembly comprises a first angled end and a second angled end;
wherein adjacent link assemblies are connectable at their respective angled ends through interlocking connection portions;
wherein the rotatable balls of the roller ball bearing assemblies are positioned to collectively support a bowling ball when the plurality of link assemblies are arranged in the radial configuration; and
wherein the plurality of link assemblies are configured to be stored in a disassembled state and reassembled without tools in a puzzle-like manner.

16. The bowling ball support kit of claim 15, wherein the interlocking connection portions comprise protrusion connection portions and recessed connection portions configured to engage with one another.

17. The bowling ball support kit of claim 16, wherein each protrusion connection portion comprises a connection interface channel and each recessed connection portion comprises a connection shoulder, the connection shoulder configured to be received within the connection interface channel of an adjacent link assembly.

18. The bowling ball support kit of claim 15, wherein the plurality of link assemblies are configured to remain connected through friction when the bowling ball support kit is lifted.

19. A bowling ball support assembly, comprising:
a plurality of link assemblies arranged in a pentagonal configuration, each link assembly comprising:
a bearing support oriented at an angle relative to horizontal; and
a roller ball bearing assembly supported by the bearing support, the roller ball bearing assembly comprising a rotatable ball;
wherein each link assembly comprises connection portions at opposite ends configured to interlock with connection portions of adjacent link assemblies;
wherein the rotatable balls are positioned to collectively support a bowling ball in a rotational manner; and
wherein the plurality of link assemblies are configured to be disassembled for storage and reassembled without tools in a puzzle-like manner.

20. The bowling ball support assembly of claim 19, wherein the plurality of link assemblies comprises three primary link assemblies each having a recessed connection portion at one end and a protrusion connection portion at an opposite end, one protrusion link assembly having protrusion connection portions at both ends, and one recessed link assembly having recessed connection portions at both ends.
